(19) United States
(12) Patent Application Publication
(10) Pub. No.: US 2015/0071544 A1
(43) Pub. Date: Mar. 12, 2015

(54) Apparatus and Non-Transitory Computer-Readable Medium Storing Computer-Readable Instructions

(71) Applicant: BROTHER KOGYO KABUSHIKI KAISHA, Nagoya-shi (JP)

(72) Inventor: Chitoshi Ito, Kasugai-shi (JP)

(21) Appl. No.: 14/478,355

(22) Filed: Sep. 5, 2014

(30) Foreign Application Priority Data
Sep. 12, 2013 (JP) 2013-189567

(51) Int. Cl. G06K 9/00; G06F 3/041; G06F 17/30; G06F 3/0354

(52) U.S. Cl. CPC G06K 9/00442; G06F 3/03545; G06F 3/041; G06F 17/30247
USPC 382/188

(57) ABSTRACT

An apparatus includes a processor and memory. The memory is configured to store computer-readable instructions, wherein the computer-readable instructions, when executed by the processor, cause the apparatus to perform processes that include acquiring type information indicating a type of a paper medium, acquiring line information indicating a plurality of positions on the paper medium, the line information being information configured to specify a line image written on the paper medium, defining an image area as one of a first area and a second area, based at least on the type information, the image area being an area included in an image, the first area being an entire area of the paper medium, and the second area including the line image and an immediate vicinity of the line image, and creating an image file for the image including the defined one of the first image area and the second image area.

### CROSS-REFERENCE TO RELATED APPLICATION

This application claims priority to Japanese Patent Application No. 2013-189567 filed Sep. 12, 2013, the content of which is hereby incorporated herein by reference.

### BACKGROUND

The present disclosure relates to an apparatus that, based on a writing operation on a paper medium, digitizes a trajectory of a writing instrument, and to a non-transitory computer-readable medium that stores computer-readable instructions.

A writing data processing device is known that, in a case where writing is performed by the writing instrument on a paper medium that is placed on a base, can digitize, based on an operation of a writing instrument, a trajectory of the writing instrument, as writing. For example, a writing data processing device is known that, in a case where writing with a pen is performed in an area of a paper medium that is equivalent to an input field, can specify coordinate data that indicate a plurality of positions where the tip of the pen has been disposed. The writing data processing device can create, based on the specified coordinate data, an image file in a bitmap format that indicates the writing.

### SUMMARY

It may be preferable for a writing data processing device to be able to vary the size of a region, on a paper medium, that is included by an image that is the basis for an image file to be created, according to how the image file to be used. For example, in a case where a user needs only the writing, it may be preferable for the writing data processing device to create an image file for an image that represents a region of the smallest size that encompasses an area where the writing is performed. This may be done to restrict the size of the image file by reducing the size of the region that is included by the image that is the basis for the image file. On the other hand, there are some cases in which the image must include the entire paper medium, including both the area where the writing is performed and the margin. In those cases, it may be preferable for the writing data processing device to create the image file for an image that represents the entire paper medium on which the writing is performed.

However, the writing data processing device that is described cannot vary the size of the region that is included by the image that is the basis for the image file to be is created.

Embodiments of the broad principles derived herein provide an apparatus that is capable of varying the size of a region that is included by an image that is the basis for an image file to be created, and also provide a non-transitory computer-readable medium that stores computer-readable instructions.

Embodiments provide an apparatus that includes a processor and a memory. The memory is configured to store computer-readable instructions, wherein the computer-readable instructions, when executed by the processor, cause the apparatus to perform processes that include acquiring type information indicating a type of a paper medium, acquiring line information indicating a plurality of positions on the paper medium, the line information being information configured to specify a line image written on the paper medium, defining an image area as one of a first area and a second area, based at least on the acquired type information, the image area being an area included in an image serving as a basis for an image file, the first area being an entire area of the paper medium on which the line image specified by the line information is written, and the second area including the line image specified by the line information and an immediate vicinity of the line image, and creating the image file for the image including the defined one of the first image area and the second image area.

Embodiments also provide a non-transitory computer-readable medium storing computer-readable instructions that, when executed by a processor of an apparatus, cause the apparatus to perform processes that include acquiring type information indicating a type of a paper medium, acquiring line information indicating a plurality of positions on the paper medium, the line information being information configured to specify a line image written on the paper medium, defining an image area as one of a first area and a second area, based at least on the acquired type information, the image area being an area included in an image serving as a basis for an image file, the first area being an entire area of the paper medium on which the line image specified by the line information is written, and the second area including the line image specified by the line information and an immediate vicinity of the line image, and creating the image file for the image including the defined one of the first image area and the second image area.

### BRIEF DESCRIPTION OF THE DRAWINGS

Embodiments will be described below in detail with reference to the accompanying drawings in which:

FIG. 1 is a figure that shows an overview of a handwriting input system 1;

FIG. 2 is a block diagram that shows an electrical configuration of a reading device 2 and a smart phone 19;

FIG. 3 is a figure that shows a form;

FIG. 4 is a figure that shows a form;

FIG. 5 is a figure that shows a form;

FIG. 6 is a figure that shows a table;

FIG. 7 is a flowchart of first main processing;

FIG. 8 is a flowchart of second main processing;

FIG. 9 is a flowchart of data acquisition processing; and

FIG. 10 is a flowchart of file creation processing.

### DETAILED DESCRIPTION

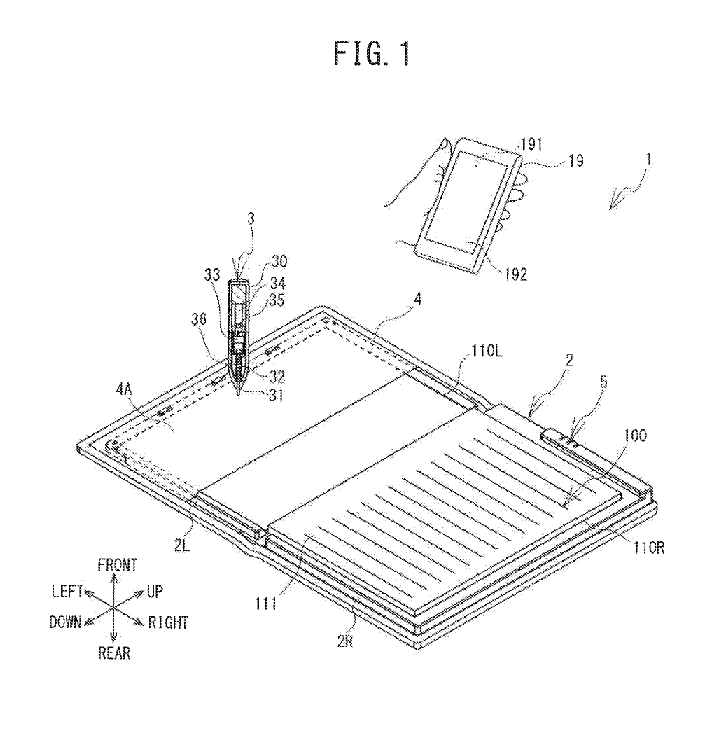

Hereinafter, an embodiment will be explained with reference to the drawings. An overview of a handwriting input system 1 according to the present embodiment will be explained with reference to FIG. 1. In the explanation that follows, the upper left side, the lower right side, the top side, the bottom side, the upper right side, and the lower left side in FIG. 1 are respectively the left side, the right side, the front side, the rear side, the top side, and the bottom side of a reading device 2.

As shown in FIG. 1, the handwriting input system 1 mainly include the reading device 2, an electronic pen 3, a smart phone 19, and the like. The reading device 2 is a thin, lightweight handwriting input device that may be folded and carried. In the handwriting input system 1, a user may use the electronic pen 3 to write a line image on a form 111 of a paper medium 100 that is mounted on the reading device 2. The line image may include a text character, a numeric character, a symbol, a graphic, and the like. The reading device 2 may specify a plurality of positions of the electronic pen 3 that change over time in the process of writing. The smart phone 19 may acquire the plurality of positions that are specified by the reading device 2. Based on the acquired plurality of positions, the smart phone 19 may specify the line image written on the form 111 by the electronic pen 3. The smart phone 19 may create an image file for an image that includes at least the specified line image. A user of the smart phone 19 may input, via a touch panel 191, a command to select one of a plurality of image files that are created. The smart phone 19 may display on a display 192 an image that corresponds to the selected image file. Through the display 192, the user may visually recognize the image that includes a line image of the same shape as the line image written on the form 111 by the electronic pen 3.

The reading device 2 mainly includes a left reading device 2L and a right reading device 2R, which form a left-right pair, and a cover 4. The left reading device 2L and the right reading device 2R are each shaped as a thin rectangular plate. The left reading device 2L and the right reading device 2R are disposed such that they can be opened out to a two-page spread in the left-right direction on the front face of the cover 4. The left reading device 2L and the right reading device 2R are electrically connected by a flat cable (not shown in the drawings). The right reading device 2R is provided with three light-emitting diodes (LEDs) 5 along its top edge. The LEDs 5 may notify the user as to the state of the reading device 2. The cover 4 includes a pouch-shaped pouch portion 4A on its left side. The left reading device 2L is removably mounted in the cover 4 by being inserted into the pouch portion 4A. The right reading device 2R is affixed to the right front face of the cover 4 by double-sided tape, an adhesive resin film, or the like.

The paper medium 100 may be removably mounted on the front face of the reading device 2. The paper medium 100 has a booklet shape that can be opened out to a two-page spread in the left-right direction. In the paper medium 100, a pair of covers (a front cover 110L and a back cover 110R) and a plurality of forms 111 are bound by a part of their edges. For example, the paper medium 100 may be an A5 size notebook. A format of the form 111 indicates the layout and the like of a pattern that is printed on the form 111 in advance. The format of the form 111 differs according to the type of the paper medium 100. The format of the form 111 may be different on each page. Hereinafter, a pattern that is printed on the form 111 in advance will be referred to as a printed pattern. The paper medium 100 is mounted on the reading device 2 such that the front cover 110L is placed on the front face of the left reading device 2L and the back cover 110R is placed on the front face of the right reading device 2R. In the present embodiment, the paper medium 100 is mounted in a state in which the paper medium 100 is positioned on the reading device 2 by double-sided tape, an adhesive resin film, or the like. In other words, the left reading device 2L and the right reading device 2R may move as a single unit with the front cover 110L and the back cover 110R, respectively. The user may use the electronic pen 3 to write a line image on the form 111 of the paper medium 100.

The electronic pen 3 is a known electromagnetic induction-type of electronic pen and mainly includes a cylindrical body 30, a core 31, a coil 32, a variable capacity capacitor 33, a circuit board 34, a capacitor 35, and an ink storage portion 36. The cylindrical body 30 has a circular cylindrical shape. The cylindrical body 30 contains in its interior a portion of the core 31, the coil 32, the variable capacity capacitor 33, the circuit board 34, the capacitor 35, and the ink storage portion 36. The core 31 is provided in the tip portion of the electronic pen 3. The core 31 is urged toward the tip of the electronic pen 3 by an elastic member that is not shown in the drawings. The tip portion of the core 31 protrudes to the outside of the cylindrical body 30. The back end of the core 31 is connected to the ink storage portion 36, which stores ink. The ink storage portion 36 supplies the ink to the core 31. When the user uses the electronic pen 3 to write on the form 111, a line image may be formed by the ink on the form 111.

The coil 32 is held between the core 31 and the variable capacity capacitor 33 in a state in which the coil 32 is wound around the ink storage portion 36. The variable capacity capacitor 33 is fixed in place in the interior of the electronic pen 3 by the circuit board 34. The capacitor 35 is mounted on the circuit board 34. The capacitor 35 and the variable capacity capacitor 33 are connected in parallel with the coil 32 to configure a known resonance (synchronization) circuit.

The smart phone 19 includes the touch panel 191 and the display 192. The touch panel 191 is used for inputting various types of commands. The display 192 may display the image that corresponds to the image file. A general-purpose PC or a tablet PC may be used instead of the smart phone 19.

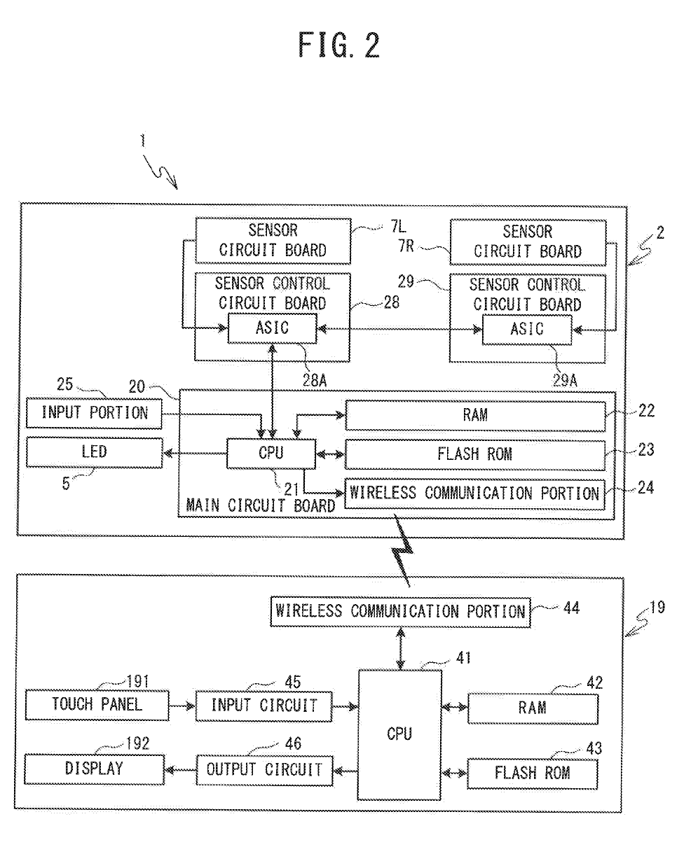

An electrical configuration of the handwriting input system 1 will be explained with reference to FIG. 2. An electrical configuration of the reading device 2 and an overview of the principles by which the reading device 2 detects coordinate data will be explained first. The reading device 2 includes sensor circuit boards 7L, 7R, a main circuit board 20, sensor control circuit boards 28, 29, an input portion 25, and the three LEDs 5. The sensor circuit boards 7L, 7R are provided inside the left reading device 2L and the right reading device 2R, respectively. The input portion 25 and the three LEDs 5 are provided in the right reading device 2R.

The main circuit board 20 is provided with a CPU 21, a RAM 22, a flash ROM 23, and a wireless communication portion 24. The RAM 22, the flash ROM 23, and the wireless communication portion 24 are electrically connected to the CPU 21. The CPU 21 performs control of the reading device 2. The RAM 22 temporarily stores various types of data such as computation data and the like. The flash ROM 23 stores various types of programs that the CPU 21 executes to control the reading device 2. The flash ROM 23 stores stroke data. The flash ROM 23 stores layout data, which will be described below, for each format of the form 111. The wireless communication portion 24 is a controller for performing near field communication with an external electronic device.

The input portion 25 and the three LEDs 5 are electrically connected to the CPU 21. The input portion 25 is a switch for inputting a command to the reading device 2. The colors of the individual three LEDs 5 are yellow, green, and red.

In each one of the sensor circuit boards 7L, 7R, a plurality of long, thin loop coils are arrayed along both an up-down axis and a left-right axis. The sensor circuit board 7L is electrically connected to an ASIC 28A of the sensor control circuit board 28. In a case where a writing operation is performed by the electronic pen 3 above the sensor circuit board 7L, the ASIC 28A can detect coordinate data that indicate the position of the electronic pen 3. The sensor circuit board 7R is electrically connected to an ASIC 29A of the sensor control circuit board 29. In a case where a writing operation is performed by the electronic pen 3 above the sensor circuit board 7R, the ASIC 29A can detect the coordinate data that indicate the position of the electronic pen 3. The ASIC 28A is the master and is connected directly to the CPU 21, while the ASIC 29A is the slave and is connected to the CPU 21 via the ASIC 28A.

The principles by which the coordinate data are detected in a case where a writing operation is performed by the electronic pen 3 on the sensor circuit boards 7L, 7R will be explained in general terms. The CPU 21 controls the ASICs 28A, 29A to cause an electric current of a specific frequency (a transmission current for excitation) to flow through each of the loop coils in the corresponding one of the sensor circuit boards 7L, 7R. This causes a magnetic field to be generated by each one of the loop coils in the sensor circuit boards 7L, 7R. In this state, if the user uses the electronic pen 3 to perform an operation of writing a line image on the form 111 of the paper medium 100 that is mounted on the reading device 2, for example, the electronic pen 3 may come close to one of the sensor circuit boards 7L, 7R. The resonance circuit of the electronic pen 3 may therefore resonate due to electromagnetic induction and may generate an induced magnetic field.

Next, the CPU 21 controls the ASICs 28A, 29A to stop the generating of the magnetic fields by the individual loop coils in the sensor circuit boards 7L, 7R. Each one of the loop coils in the sensor circuit boards 7L, 7R can receive the induced magnetic field that is generated by the resonance circuit of the electronic pen 3. The CPU 21 controls the ASICs 28A, 29A to detect signal currents (reception currents) that flow through the individual loop coils in the sensor circuit boards 7L, 7R. By performing this operation for each of the loop coils and detecting the reception currents, the ASICs 28A, 29A can detect the coordinate data that describe the position of the electronic pen 3.

When a line image is written on the form 111 using the electronic pen 3, a writing pressure is imparted to the core 31. The inductance in the coil 32 varies according to the writing pressure that is imparted to the core 31. This causes the resonance frequency of the resonance circuit of the electronic pen 3 to vary in accordance with the writing pressure that is imparted to the core 31. The CPU 21 detects the changes (phase changes) in the resonance frequency to specify the writing pressure that is imparted to the core 31. In other words, the CPU 21 can determine, according to the specified writing pressure, whether a line image is being written by the electronic pen 3 on the form 111 of the paper medium 100.

In a case where the CPU 21 determines that a line image is being written on the form 111, the CPU 21 acquires the coordinate data that are detected via the ASICs 28A, 29A and that indicate the positions of the electronic pen 3, then stores the coordinate data in the RAM 22. The CPU 21 repeatedly acquires the coordinate data at specified intervals while the CPU 21 determines that the line image is being written on the form 111. In a case where the CPU 21 detects a command to store the line image written on the form 111, the CPU 21 creates stroke data based on the coordinate data that indicate the plurality of positions of the electronic pen 3 and that are stored in the RAM 22. The specific method by which the CPU 21 detects the command to store the line image written on the form 111 will be described below. The stroke data include the coordinate data that indicate the plurality of positions of the electronic pen 3 that are acquired from the time when the command to store the line image is detected until the next time the command to store the line image is detected. The CPU 21 stores the created stroke data in the flash ROM 23.

Next, an electrical configuration of the smart phone 19 and an overview of processing in a case where the smart phone 19 acquires the stroke data from the reading device 2 will be explained. The smart phone 19 mainly indicates a CPU 41, a RAM 42, a flash ROM 43, a wireless communication portion 44, an input circuit 45, an output circuit 46, the touch panel 191, and the display 192. The CPU 41 performs control of the smart phone 19. The CPU 41 is electrically connected to the RAM 42, the flash ROM 43, the wireless communication portion 44, the input circuit 45, and the output circuit 46.

The RAM 42 stores various types of data temporarily. The wireless communication portion 44 is a controller for performing near field communication with an external electronic device. The input circuit 45 performs control for sending a command to the CPU 41 from the touch panel 191. The output circuit 46 performs control for displaying an image on the display 192 in response to a command from the CPU 41.

Various types of programs that the CPU 41 executes are stored in the flash ROM 43. The smart phone 19 is provided with a media reading device (for example, a memory card slot) that is not shown in the drawings. The smart phone 19 can read a program that is stored in a storage medium (for example, a memory card) with the media reading device and can install the program in the flash ROM 43. The smart phone 19 may also receive a program from an external device (not shown in the drawings) that is connected to the smart phone 19, or from a network, and then install the program in the flash ROM 43.

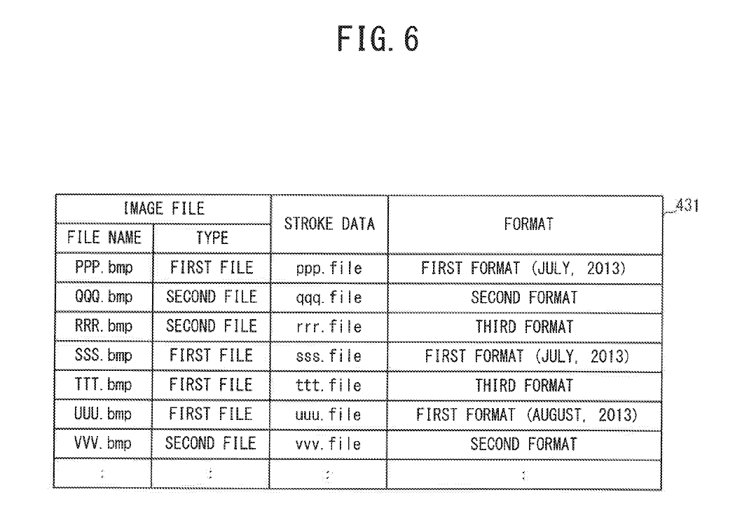

The flash ROM 43 stores printed pattern data, which will be described below, for each format of the form 111. The flash ROM 43 stores a table 431 (refer to FIG. 6).

In a case where a command to acquire the stroke data from the reading device 2 is input via the touch panel 191, the CPU 41 performs near field communication with the reading device 2 via the wireless communication portion 44. The stroke data that are stored in the flash ROM 23 of the reading device 2 may be transmitted wirelessly from the reading device 2 to the smart phone 19. The CPU 41 may receive the stroke data wirelessly transmitted from the reading device 2 and may store the stroke data in the RAM 42. Based on the stroke data stored in the RAM 42, the CPU 41 may create an image file that indicates a line image of the same shape as the line image written on the form 111 by the electronic pen 3. The communication in a case where the stroke data are transmitted from the reading device 2 to the smart phone 19 is not limited to being wireless communication, and the communication may be wire communication.

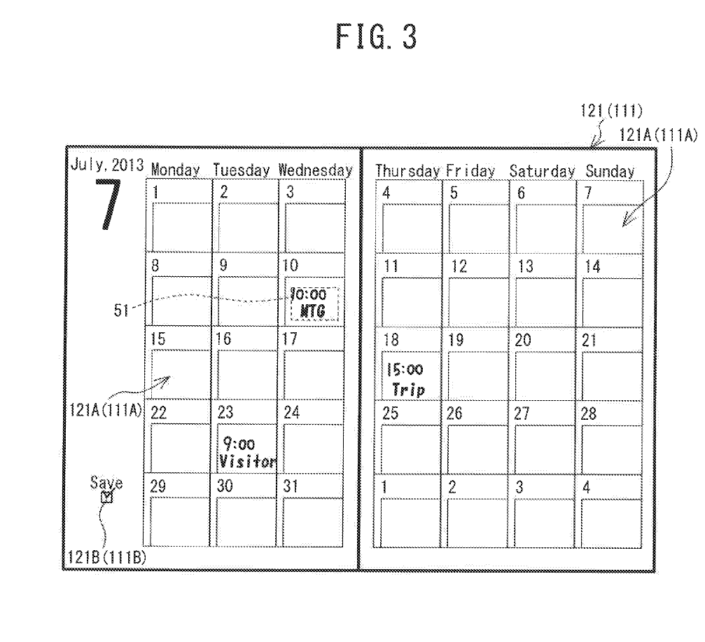

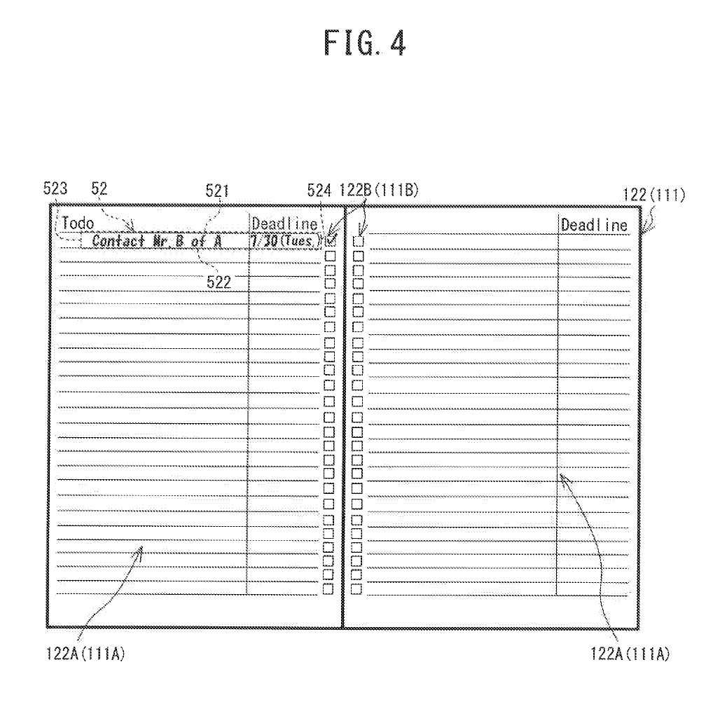

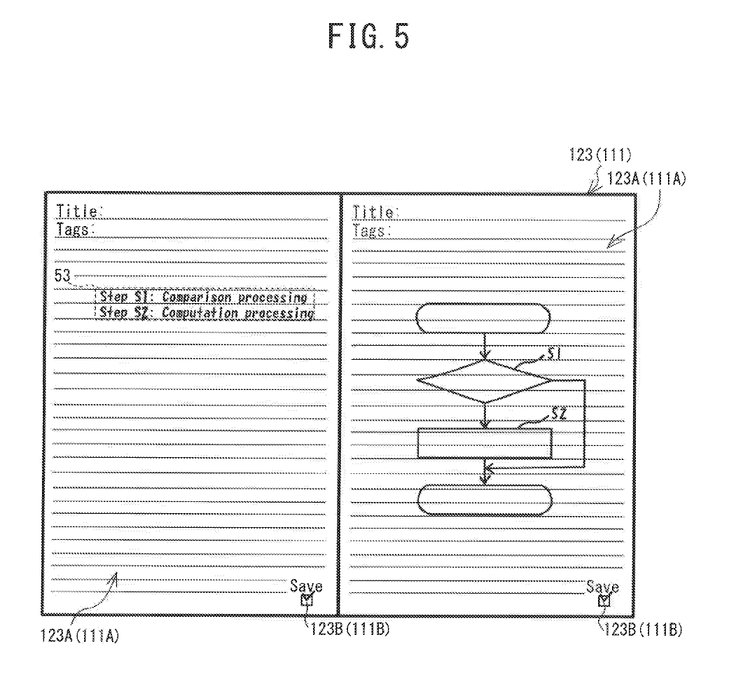

A form 121 (refer to FIG. 3), a form 122 (refer to FIG. 4), and a form 123 (refer to FIG. 5), which are specific examples of the form 111 of the paper medium 100, will be explained with reference to FIGS. 3 to 5. The left side, the right side, the top side, and the bottom side in FIGS. 3 to 5 are respectively the left side, the right side, the top side, and the bottom side of the form 111. The FIGS. 3 to 5 show the forms 121 to 123, respectively, of two pages that are placed when the paper medium 100 is in the open state.

As shown in FIG. 3, the form 121 is a schedule form for entering a schedule for the month of July, 2013. The form 121 of two pages that are placed when the paper medium 100 is in the open state is equivalent to a schedule form for one month. The two-page form 121 includes writing areas 121A and a check box 121B. The writing areas 121A are disposed, within the two-page form 121, on the entire right page and a portion of the left page. Text characters that indicate the days of the week, numeric characters that indicate dates, and lines that partition the writing areas 121A into sections for the individual dates are printed in the writing areas 121A. The writing areas 121A are areas for the user to write schedule for the individual dates using the electronic pen 3. The check box 121B is printed to the lower left of the writing area 121A on the left page of the form 121. The check box 121B is an area for the user to write a check mark to save, in a unit of two pages, the line images written in the writing areas 121A. In a case where the combination of the month and the year that corresponds to the two-page form 121 is different from that in FIG. 3 (July, 2013), the position where the check box 121B is printed is different from that in FIG. 3, although that is not shown in the drawings. The position where the check box 121B is printed varies slightly for each combination of the month and the year.

As shown in FIG. 4, the form 122 is a form for writing a to-do list. The form 122 includes writing areas 122A and check boxes 122B. A plurality of ruled lines that each extend in the left-right direction are printed at equal intervals from the top to the bottom of each of the writing areas 122A. A line that extends in the up-down direction is printed near the right ends of the plurality of ruled lines and demarcates an area for writing a deadline (a date and the day of the week). The writing areas 122A are areas for the user to write tasks to be done and their deadlines. On the left page of the form 122, a plurality of check boxes 122B are printed at the right side of the plurality of ruled lines, one of the check boxes 122B between each adjacent two of the ruled lines. On the right page of the form 122, a plurality of check boxes 122B are printed at the left side of the plurality of ruled lines, one of the check boxes 122B between each adjacent two of the ruled lines. Each one of the plurality of check boxes 122B is an area for the user to write a check mark to save the line image that is written above the corresponding ruled line in the writing area 122A.

As shown in FIG. 5, the form 123 is a memo form for writing a memo. The form 123 includes writing areas 123A and check boxes 123B. A plurality of ruled lines that each extend in the left-right direction are printed at equal intervals from the top to the bottom of the writing areas 123A. The text “Title:” is printed at the left end of the uppermost ruled line, and the text “Tags:” is printed at the left end of the second ruled line. The writing areas 123A are areas for the user to write a memo. Each of the check boxes 123B is printed to the lower right of the corresponding one of the writing areas 123A. Each one of the check boxes 123B is an area for the user to write a check mark to save, in a unit of one page, the line image that are written in the corresponding one of the writing areas 123A.

Hereinafter, the writing areas 121A (refer to FIG. 3), the writing areas 122A (refer to FIG. 4), and the writing areas 123A (refer to FIG. 5) will collectively be referred to as the writing areas 111A. The check box 121B (refer to FIG. 3), the check boxes 122B (refer to FIG. 4), and the check boxes 123B (refer to FIG. 5) will collectively be referred to as the check boxes 111B. The formats of the form 121 (refer to FIG. 3), the form 122 (refer to FIG. 4), and the form 123 (refer to FIG. 5) will respectively be referred to as the first format, the second format, and the third format. In the present embodiment, it is assumed that the paper medium 100 that contains one of the form 121 (refer to FIG. 3), the form 122 (refer to FIG. 4), and the form 123 (refer to FIG. 5) is mounted on the reading device 2 and used.

An overview of the image file that is created based on the line image that is written on the form 111 will be explained. The CPU 21 of the reading device 2 repeatedly acquires and stores in the RAM 22 the coordinate data that indicate the positions of the electronic pen 3 while the line image is being written by the electronic pen 3 in the writing area 111A of the form 111 of the paper medium 100 that is mounted on the reading device 2. The coordinate data that indicate the plurality of positions in each of the lines that make up the line image are stored in the RAM 22 in a state in which the plurality of positions are grouped. In a case where the CPU 21 determines that a check mark is written in the check box 111B, the CPU 21 creates the stroke data that include the coordinate data that indicate the plurality of positions stored in the RAM 22. The CPU 21 stores the created stroke data in the flash ROM 23. In response to a command from the smart phone 19, the CPU 21 transmits to the smart phone 19 the stroke data stored in the flash ROM 23. The CPU 41 of the smart phone 19 receives the stroke data transmitted from the reading device 2 and stores the stroke data in the RAM 42.

The CPU 41 extracts, in group units, the coordinate data that are included in the received stroke data and that indicate the plurality of positions. The CPU 41 connects, with straight lines, the plurality of positions that are indicated by the extracted coordinate data, in the order in which the electronic pen 3 moved to those positions. The CPU 41 connects the lines that are each produced for each group and specifies the result as the written line image. The CPU 41 creates an image file for an image that includes at least the specified line image. The image file is a data file that indicates the line image in the form of a digital image. Examples of the digital image may include a vector image and a raster image. The image file may be any one of a JPEG file, a GIF file, a PNG file, and a BMP file.

The image files that are created in a case where line images are written on the form 121 (refer to FIG. 3), the form 122 (refer to FIG. 4), and the form 123 (refer to FIG. 5), respectively, will be explained. First, the image file that is created in a case where a line image is written on the form 121, as shown in FIG. 3, will be explained. In a case where a line image is written in the writing area 121A of the form 121 and a check mark is written in the check box 121B, the CPU 41 creates an image file for an image that includes the entire two-page form 121 on which the line image is written. The reason for doing this will now be explained. An example will be explained in which the character string “10:00 MTG” is written in the space that corresponds to July 10 within the writing area 121A of the form 121 and a check mark is written in the check box 121B. If the character string “10:00 MTG” is not associated with the date (July 10) that is indicated by the area in which the character string is written, it may not function as valid information that indicates a scheduled item. Therefore, if an image file is created for an image that includes only the area that is bounded by a rectangle 51, which is the area within which the character string “10:00 MTG” is located, the user may not specify the date that corresponds to the written character string based on the image file.

Therefore, in a case where a character string is written on one of the two pages of the form 121, the CPU 41 creates an image file for an image that includes the entire two-page form 121. More specifically, the CPU 41 creates an image file for an image that includes the written character string “10:00 MTG” and the printed pattern that is printed on the two-page form 121. In this case, as shown in FIG. 3, the printed pattern that is printed on the two-page form 121 includes the text characters that indicate the days of the week, the numeric characters that indicate the dates, and the lines that partition the writing areas 121A into sections for the individual dates, all of which are printed in the writing areas 121A, as well as the check box 121B. The area that is included by the image is the entire two-page form 121 in the two-page spread state. Hereinafter, an image file for an image that includes the entire form 111 on which a line image is written (in the case of the form 121, the entire two-page form 121 in the two-page spread state) will be referred to as a first file.

The CPU 41 can specify the printed pattern that is printed on the two-page form 121 based on the printed pattern data, which are stored in the flash ROM 23. The printed pattern data include the coordinate data that indicate the positions in the upper left portion (the upper left portion of the left page of the form 121), the lower left portion (the lower left portion of the left page of the form 121), the upper right portion (the upper right portion of the right page of the form 121), and the lower right portion (the lower right portion of the right page of the form 121) of the two-page form 121. The printed pattern data also include the coordinate data that indicate the positions where the printed pattern is disposed on the two-page form 121. By superimposing the written line image, which is specified based on the stroke data that are received from the reading device 2, on the printed pattern, which is specified based on the printed pattern data, the CPU 41 can create the image that is the basis for the image file. The CPU 41 superimposes the written line image on the printed pattern by adjusting the positional relationship between the printed pattern and the written line image such that the coordinate data that are included in the printed pattern data correspond to the coordinate data that are included in the stroke data. The CPU 41 thus can create an image that reproduces the entire two-page form 121 on which the line image is written.

The printed pattern data that correspond to the two-page form 121 include printed pattern data that differ according to the year and the month. The printed pattern data that differ according to the year and the month can indicate printed patterns that differ according to the year and the month. The flash ROM 23 stores not only the printed pattern data that correspond to the two-page form 121, but also the printed pattern data that correspond to the forms 122, 123.

The CPU 41 may include in the image only the printed pattern that is printed in the writing areas 121A and may not include the check box 121B in the image because the user may specify the date that corresponds to the written character string, based on the image file, even in a case where the check box 121B is not included in the image.

Next, the image file that is created in a case where a line image is written on the form 122, as shown in FIG. 4, will be explained. In a case where a line image is written in one of the writing areas 122A of the form 122 and a check mark is written in the corresponding check box 122B, the CPU 41 creates an image file for an image that includes only the area within which the line image is written. The reason for doing this will now be explained. An example will be explained in which the character string “Contact Mr. B of A 7/30 (Tues.)” is written in one of the writing areas 122A of the form 122 and a check mark is written in the corresponding check box 122B. Here, in a case where the image file (the first file) is created for an image that includes the entire form 122 on which the character string “Contact Mr. B of A 7/30 (Tues.)” is written, in the same manner as in the case of the form 121, the printed pattern (of the ruled lines) that is printed on the form 122 and margin areas that do not include the written character string are included in the image. In most cases, the printed pattern and the margin areas may not needed when the user checks the to-do list. Furthermore, the size of the image file for an image that does not include the printed pattern and the margin areas is smaller than the size of the image file for an image that does include the printed pattern and the margin areas. It is therefore preferable to exclude the printed pattern and the margin areas from the image.

Therefore, in a case where a character string is written on the form 122, the CPU 41 creates the image file for an image that includes only the area within which the line image is written. This will now be explained in greater detail. The CPU 41 specifies the uppermost position, the lowermost position, the leftmost position, and the rightmost position of the written character string. These positions are specified by the coordinate data that, among the coordinate data that indicate the plurality of positions that are included in the stroke data that indicate the character string, indicate the uppermost position, the lowermost position, the leftmost position, and the rightmost position on the paper medium 100. The CPU 41 specifies a rectangle 52 that is bounded by straight lines 521 to 524. The straight line 521 extends in the left-right direction through the uppermost position. The straight line 522 extends in the left-right direction through the lowermost position. The straight line 523 extends in the up-down direction through the leftmost position. The straight line 524 extends in the up-down direction through the rightmost position. The rectangle 52 is the smallest rectangle that encompasses the area where the character string is written. The CPU 41 creates the image file for an image that includes only the area that is bounded by the specified rectangle 52. The area that is bounded by the specified smallest rectangle, as described above, is equivalent to the area within which the character string is written. Hereinafter, an image file for an image that includes only an area within which a line image is written will be referred to as a second file.

Next, the image file that is created in a case where a line image is written on the form 123, as shown in FIG. 5, will be explained. In a case where a line image is written in one of the writing areas 123A of the form 123 and a check mark is written in the corresponding check box 123B, the CPU 41 determines which one of the first file and the second file to create, then creates the determined one of the first file and the second file. The reason for doing this will now be explained. An example will be explained in which the character strings “Step S1: Comparison processing” and “Step S2: Computation processing” are written in the writing area 123A on the left page of the form 123 and a check mark is written in the check box 123B on the left page of the form 123. In most cases like this, on the left page of the form 123, the printed pattern (of the ruled lines) that is printed in the writing area 123A and the margin area that does not include the character strings “Step S1: Comparison processing” and “Step S2: Computation processing” may not needed when the user checks the memo. Moreover, the margin area is large. Therefore, the size of the image file for an image that does not include the margin area is much smaller than the size of the image file for an image that does include the margin area. The CPU 41 therefore creates the image file for an image that includes only the area where the character string is written, in other words, the area that is bounded by a rectangle 53, that is, the second file.

Next, another example will be explained in which a flowchart is written in the writing area 123A on the right page of the form 123 and a check mark is written in the check box 123B on the right page of the form 123. In this case, the margin area on the right page of the form 123 that does not include the flowchart is small. Therefore, the difference is small between the size of the image file for an image that does not include the margin area and the size of the image file for an image that does include the margin area, so the effect of reducing the file size is limited. The CPU 41 therefore creates the image file for an image that includes the entire right page of the form 123 on which the flowchart is written, that is, the first file.

The specific method by which the CPU 41 determines which one of the first file and the second file to create in a case where a line image is written in the writing area 123A of the form 123 will be described below. In a case where the CPU 41 determines that the first file will be created, the CPU 41 may create the first file without including the printed pattern that is printed on the form 123. The reason for this is that in most cases, the printed pattern that is printed on the form 123 is not needed when the user checks the memo.

FIG. 6 shows the table 431 that is stored in the flash ROM 43. In a case where the CPU 41 creates the image file by the method that is described above, the CPU 41 stores the created image file in the table 431. The CPU 41 associates type information, the stroke data, and format information with the stored image file. The type information is information that indicates whether the created image file is the first file or the second file. The stroke data are the stroke data used to specify the line image that is included in the image that is the basis for the image file. The format information is information that indicates the format of the form 111 on which the line image that was specified by the stroke data is written. In a case where the format is the first format, the format information includes information that indicates the year and the month, because the format of the printed pattern that is printed on the form 121 differs according to the combination of the year and the month.

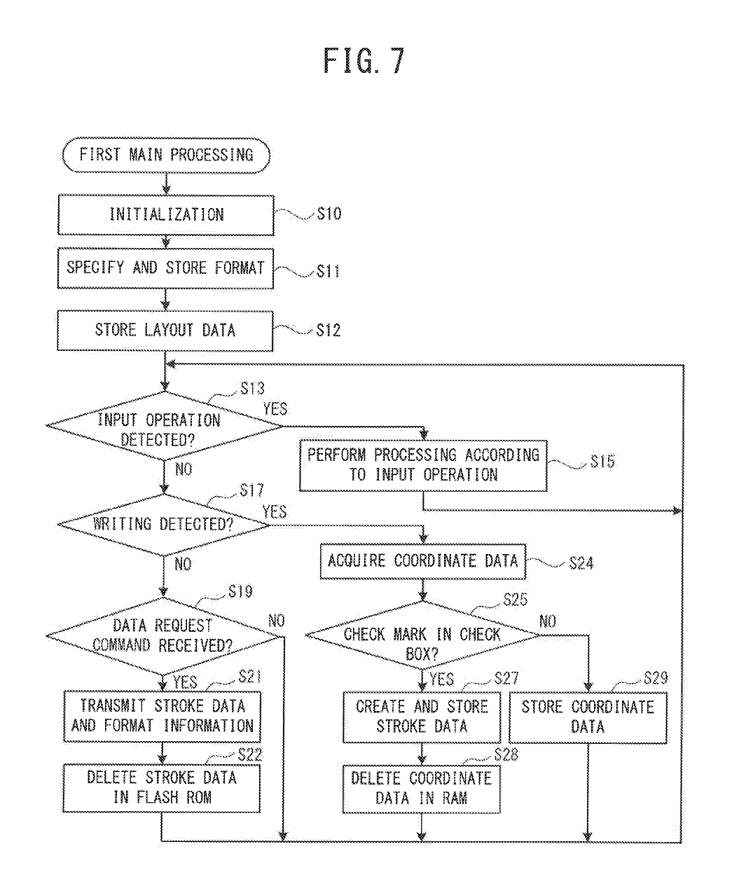

First main processing that is performed by the CPU 21 of the reading device 2 will be explained with reference to FIG. 7. When the power supply is turned on, the CPU 21 starts the first main processing by operating based on a program that is stored in the flash ROM 23.

First, the CPU 21 performs initialization (Step S 10), which will now be explained. The CPU 21 deletes data that are stored in the RAM 22. The CPU 21 starts control of the ASICs 28A, 29A. That establishes a state in which the CPU 21 can determine whether a line image is being written by the electronic pen 3 on the form 111 of the paper medium 100 that is mounted on the reading device 2. In a case where the CPU 21 determines that a line image is being written by the electronic pen 3, the CPU 21 can acquire the coordinate data that indicate the position of the electronic pen 3.

The CPU 21 specifies the format of the form 111 of the paper medium 100 that is mounted on the reading device 2 (Step S11). Specifically, the CPU 21 specifies the format as will now be explained. The CPU 21 turns on the red LED 5 in order to notify the user that the format of the form 111 is not specified. Using the electronic pen 3, the user may write check marks in a plurality of calibration mark positions, which are printed in a corner of the form 111 and are not shown in the drawings, in an order that corresponds to the format of the form 111. The CPU 21 acquires, in order, the coordinate data that indicate the positions where the check marks are written, then specifies the positions where the check marks are written and the order in which the check marks are written. The CPU 21 specifies the format of the form 111 that corresponds to the specified positions and order (Step S11). The CPU 21 stores in the RAM 22 the format information that indicates the specified format of the form 111 (Step S11). The CPU 21 turns on the green LED 5 in order to notify the user that the format of the form 111 is specified.

The CPU 21 may specify the format of the form 111 by a different method from that described above. For example, via the input portion 25, the user may perform an input operation that inputs the format of the form 111 of the paper medium 100 that is mounted on the reading device 2. The CPU 21 may detect the input operation on the input portion 25 and may specify the format that corresponds to the input operation as the format of the form 111 of the paper medium 100 that is mounted on the reading device 2.

The CPU 21 reads from the flash ROM 23 the layout data that correspond to the specified format, then stores the layout data in the RAM 22 (Step S12). The layout data include data that indicate the respective positions of the writing area 111A and the check box 111B of the form 111. As explained with reference to FIG. 3, in the case of the form 121 with the first format, the position of the check box 121B varies according to the year and the month. Therefore, the layout data that correspond to the first format include data that indicate the positions of the check box 121B that vary according to the year and the month. The layout data also include data that indicate the years and the months that correspond to the various positions of the check box 121B.

The CPU 21 determines whether an input operation on the input portion 25 is detected (Step S13). In a case where the CPU 21 determines that an input operation on the input portion 25 is detected (YES at Step S13), the CPU 21 specifies the processing that corresponds to the detected input operation. Specific examples of the processing include restart processing in a case where an abnormality occurs, processing that re-specifies the format of the form 111, and the like. The CPU 21 performs processing based on the specified processing (Step S15). The CPU 21 then returns the processing to Step S13.

In a case where the CPU 21 determines that an input operation on the input portion 25 is not detected (NO at Step S13), the CPU 21 determines whether a line image is being written on the form 111 (Step S17). In a case where the CPU 21 determines that a line image is being written on the form 111 (YES at Step S17), the CPU 21 acquires the coordinate data that indicate the position of the electronic pen 3 (Step S24). Based on the layout data stored in the RAM 22 at Step S12, the CPU 21 specifies the position, on the form 111, where the check box 111B is printed. Based on the coordinate data that are acquired at Step S24, the CPU 21 determines whether a check mark is being written in the specified position of the check box 111B (Step S25).

In a case where the CPU 21 determines that a check mark is not written in the position of the check box 111B (NO at Step S25), the CPU 21 determines that a line image is written in the writing area 111A of the form 111. The CPU 21 stores in the RAM 22 the coordinate data that are acquired at Step S24 (Step S29). The CPU 21 then returns the processing to Step S13. In a case where the CPU 21 determines that a check mark is written in the position of the check box 111B (YES at Step S25), the CPU 21 creates stroke data that include the plurality of coordinate data sets that are stored in the RAM 22 at Step S29 (Step S27). The CPU 21 stores the created stroke data in the flash ROM 23 (Step S27). The CPU 21 deletes the coordinate data that are stored in the RAM 22 (Step S28). The CPU 21 then returns the processing to Step S13.

The layout data that correspond to the first format include data that indicate the positions of a plurality of check boxes 121B that correspond to a plurality of combinations of the year and the month. In a case where the format that is indicated by the format information that is specified and stored in the RAM 22 at Step S11 is the first format (refer to FIG. 3), the CPU 21, in the processing at Step S25, determines whether a check mark is written in any one of the plurality of check boxes 121B. In a case where the CPU 21 determines that a check mark is written in any one of the plurality of check boxes 121B (YES at Step S25), the CPU 21, based on the layout data, specifies the combination of the year and the month that corresponds to the check box 121B in which the check mark is written. The CPU 21 incorporates, into the format information stored in the RAM 22 at Step S11, information that indicates the specified combination of the year and the month.

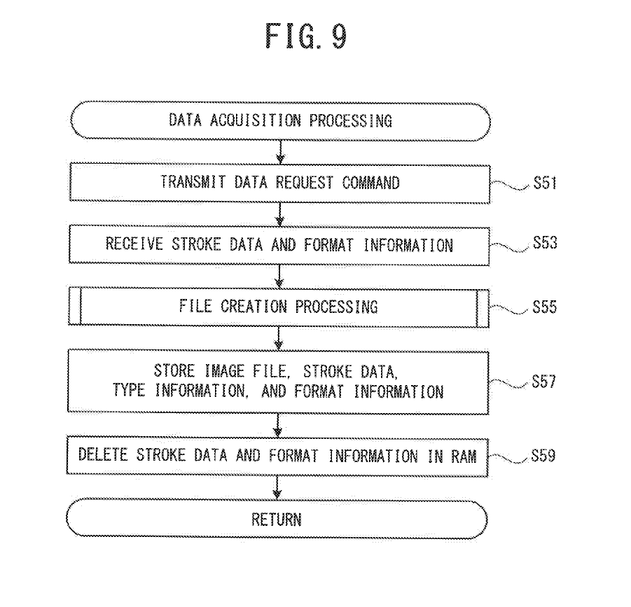

In a case where the CPU 21 determines that a line image is not written on the form 111 (NO at Step S17), the CPU 21 determines whether a data request command (refer to FIG. 9, Step S51), which is wirelessly transmitted from the smart phone 19, is received via the wireless communication portion 24 (Step S19). In a case where the CPU 21 determines that a data request command is not received (NO at Step S19), the CPU 21 returns the processing to Step S13. In a case where the CPU 21 determines that a data request command is received (YES at Step S19), the CPU 21 wirelessly transmits to the smart phone 19, via the wireless communication portion 24, the stroke data that are stored in the flash ROM 23 at Step S27 and the format information that is stored in the RAM 22 at Step S11 (Step S21). The CPU 21 deletes the stroke data that are stored in the flash ROM 23 (Step S22). The CPU 21 then returns the processing to Step S13.

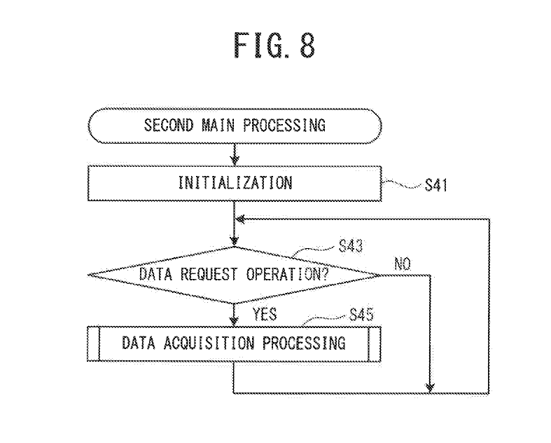

Second main processing that is performed by the CPU 41 of the smart phone 19 will be explained with reference to FIG. 8. When an operation to launch an application for wirelessly communicating with the reading device 2 is performed via the touch panel 191, the CPU 41 starts the second main processing by operating based on a program that is stored in the flash ROM 43.

First, the CPU 41 performs initialization (Step S41), which will now be explained. The CPU 41 deletes data that are stored in the RAM 42. In order to start the wireless communication with the reading device 2, the CPU 41 transmits and receives an identification data (ID) and the like to and from the reading device 2. The CPU 41 displays a plurality of menu buttons on the display 192.

The CPU 41 determines whether an operation to select a menu button for acquiring the stroke data that are stored in reading device 2 is detected via the touch panel 191 (Step S43). In a case where the CPU 41 determines that the operation to select the menu button for acquiring the stroke data is not detected (NO at Step S43), the CPU 41 returns the processing to Step S43. In a case where the CPU 41 determines that the operation to select the menu button for acquiring the stroke data is detected (YES at Step S43), the CPU 41 performs data acquisition processing (refer to FIG. 9) (Step S45).

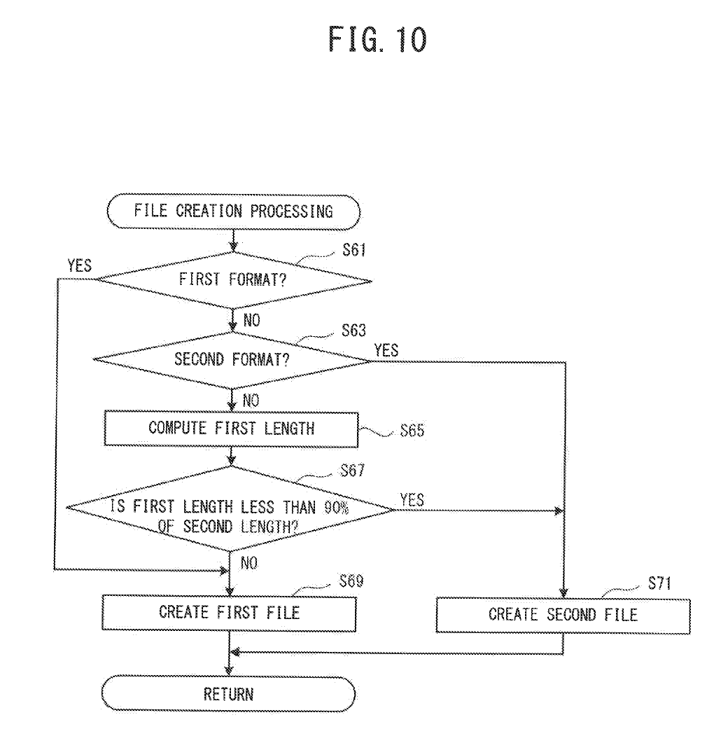

The data acquisition processing will be explained with reference to FIG. 9. Via the wireless communication portion 44, the CPU 41 wirelessly transmits the data request command, which requests the acquisition of the stroke data, to the reading device 2 (Step S51). Via the wireless communication portion 44, the CPU 41 receives the stroke data and the format information that are wirelessly transmitted from the reading device 2 (refer to FIG. 7, Step S21) in response to the transmitted data request command (Step S53). The CPU 41 stores the received stroke data and format information in the RAM 42. The CPU 41 performs file creation processing (refer to FIG. 10) (Step S55).

The file creation processing will be explained with reference to FIG. 10. The CPU 41 determines whether the format that is indicated by the format information that is stored in the RAM 42 is the first format (Step S61). In a case where the format that is indicated by the format information is the first format, the paper medium 100 that includes the form 121 (refer to FIG. 3) is mounted on the reading device 2. The stroke data that are stored in the RAM 42 correspond to the line image that is written on the form 121 by the electronic pen 3. In a case where the CPU 41 determines that the format that is indicated by the format information is the first format (YES at Step S61), the CPU 41 creates the first file (Step S69). This will now be explained in detail.

From the printed pattern data stored in the flash ROM 43, the CPU 41 extracts the printed pattern data that correspond to the plurality of printed patterns that correspond to the first format. The printed pattern data that correspond to each of the plurality of printed patterns correspond to a different combination of the year and the month. The format information for the first format also includes information that indicates a specific combination of the year and the month. From the printed pattern data that correspond to the plurality of printed patterns that correspond to the first format, the CPU 41 extracts the printed pattern data that correspond to the combination of the year and the month that is included in the format information. In this manner, the CPU 41 extracts, as the printed pattern data for the first format that corresponds to July, 2013, for example, data that indicate the printed pattern that is printed on the two-page form 121 that is shown in FIG. 3. The CPU 41 specifies the written line image, based on the coordinate data that are included in the stroke data stored in the RAM 42 and that indicate the plurality of positions. The CPU 41 creates the image file (the first file) for an image in which the specified line image is superimposed on the printed pattern that is specified by the extracted printed pattern data. The CPU 41 terminates the file creation processing and returns the processing to the data acquisition processing (refer to FIG. 9).

In a case where the CPU 41 determines that the format that is indicated by the format information that is stored in the RAM 42 is not the first format (NO at Step S61), the CPU 41 determines whether the format that is indicated by the format information is the second format (Step S63). In a case where the format that is indicated by the format information is the second format, the paper medium 100 that indicates the form 122 (refer to FIG. 4) is mounted on the reading device 2. The stroke data that are stored in the RAM 42 correspond to the line image that is written on the form 122 by the electronic pen 3. In a case where the CPU 41 determines that the format that is indicated by the format information that is stored in the RAM 42 is the second format (YES at Step S63), the CPU 41 creates the second file (Step S71). This will now be explained in detail.

The CPU 41 specifies the written line image, based on the coordinate data that indicate the plurality of positions that are included in the stroke data stored in the RAM 42. The CPU 41 specifies the smallest rectangle that encompasses the specified line image. The specified line image fits precisely within the specified rectangle. The CPU 41 creates the image file (the second file) for an image that represents only the area within the specified rectangle. The CPU 41 terminates the file creation processing and returns the processing to the data acquisition processing (refer to FIG. 9).

In a case where the CPU 41 determines that the format that is indicated by the format information that is stored in the RAM 42 is not the second format (NO at Step S63), the CPU 41 determines that the format is the third format. The CPU 41 specifies the written line image, based on the coordinate data that indicate the plurality of positions that are included in the stroke data stored in the RAM 42. By the same method as that of creating the second file, the CPU 41 specifies the smallest rectangle that encompasses the specified line image. The CPU 41 computes the length (hereinafter referred to as the first length), in the up-down direction, of the specified rectangle, based on the coordinate data that are included in the stroke data (Step S65). The CPU 41 computes the length (hereinafter referred to as the second length), in the up-down direction, of the form 123 (refer to FIG. 5) of the third format, based on the printed pattern data that correspond to the third format, among the printed pattern data that correspond to the plurality of printed patterns stored in the flash ROM 43.

The CPU 41 compares the first length and the second length and determines whether the first length is less than 90% of the second length (Step S67). In a case where the CPU 41 determines that the first length is not less than 90% of the second length (NO at Step S67), the CPU 41 creates the first file (Step S69). This will now be explained in specific terms. The CPU 41 extracts, from among the printed pattern data stored in the flash ROM 43, the printed pattern data that correspond to the third format. The CPU 41 specifies the written line image, based on the coordinate data that indicate the plurality of positions that are included in the stroke data stored in the RAM 42. The CPU 41 creates the image file (the first file) for an image in which the specified line image is superimposed on the printed pattern that is specified by the extracted printed pattern data. The CPU 41 terminates the file creation processing and returns the processing to the data acquisition processing (refer to FIG. 9).

On the other hand, in a case where the CPU 41 determines that the first length is less than 90% of the second length (YES at Step S67), the CPU 41 creates the second file (Step S71). This will now be explained in specific terms. The CPU 41 specifies the written line image, based on the coordinate data that indicate the plurality of positions that are included in the stroke data stored in the RAM 42. The CPU 41 specifies the smallest rectangle that encompasses the specified line image. The CPU 41 creates the image file (the second file) for an image that represents only the area within the specified rectangle. The CPU 41 terminates the file creation processing and returns the processing to the data acquisition processing (refer to FIG. 9).

As shown in FIG. 9, after terminating the file creation processing (Step S55), the CPU 41 stores in the table 431 the image file created in the file creation processing (refer to FIG. 6) (Step S57). The CPU 41 stores in the table 431 the type information, which indicates the type of the image file (the first file or the second file), in association with the created image file (Step S57). The CPU 41 stores in the table 431 the stroke data stored in the RAM 42, in association with the created image file (Step S57). The CPU 41 stores in the table 431 the format information stored in the RAM 42, in association with the created image file (Step S57). The CPU 41 deletes the stroke data and the format information that are stored in the RAM 42 (Step S59). The CPU 41 terminates the data acquisition processing and returns the processing to the second main processing (refer to FIG. 8). As shown in FIG. 8, after terminating the data acquisition processing (Step S45), the CPU 41 returns the processing to Step S43.

As explained above, in a case where the format of the form 111 of the paper medium 100 on which the line image is written by the electronic pen 3 is the first format, the smart phone 19 creates the first file. In a case where the format of the form 111 of the paper medium 100 on which the line image is written by the electronic pen 3 is the second format, the smart phone 19 creates the second file. The entire form 111 on which the line image is written is included in the image that is the basis for the first file. In contrast, only the area within which the line image is written is included in the image that is the basis for the second file. Therefore, the smart phone 19 can determines, as the size of the area that is included in the image, an appropriate size that is suited to the format of the form 111 on which the line image is written.

For example, in a case where a schedule is written on the form 121, the smart phone 19 creates the first file. The written schedule and the printed pattern that is printed on the form 121 are included in the image that is the basis for the first file. Therefore, by displaying on the display 192 the image that corresponds to the created first file, the user may check the schedule item in association with the schedule date that is printed on the form 121.

In a case where a character string is written on the form 122, for example, the smart phone 19 creates the second file. Only the area inside the rectangle that encompasses the written character string is included in the image that is the basis for the second file. By displaying on the display 192 the image that corresponds to the created second file, the user may check the content of the character string written on the form 122. Moreover, the size of the area inside the rectangle that is included in the image is smaller than the size of the form 122. Therefore, the smart phone 19 can create the second file with a smaller size than that of the first file.

In a case where the format of the form 111 of the paper medium 100 on which the line image is written by the electronic pen 3 is the third format, the smart phone 19 determines which one of the first file and the second file to create, according to the relationship between the length (the first length), in the up-down direction, of the smallest rectangle that encompasses the line image and the length (the second length), in the up-down direction, of the form 111. Specifically, the smart phone 19 creates the first file in a case where the first length is not less than 90% of the second length and creates the second file in a case where the first length is less than 90% of the second length. In this manner, the smart phone 19 can create the first file in a case where the effect of reducing the file size is small, and can create the second file in a case where the effect of reducing the file size is great.

In the image that is the basis for the second file, the smart phone 19 includes the area inside the smallest rectangle that encompasses the written line image. The smart phone 19 can thus minimize the size of the created second file, while retaining the written line image in the image.

Hereinafter, examples of modifications that can be applied to the embodiment that is described above will be described. Various types of processing that are performed by the CPU 41 of the smart phone 19 in the above embodiment may be performed by the CPU 21 of the reading device 2. The method of detecting the position of the electronic pen 3 in the above embodiment can be changed to another method. For example, the reading device 2 may include a touch panel on its top face. In that case, the position where writing is performed by the electronic pen 3 corresponds to a position where the touch panel is pressed. Therefore, from the touch panel, the CPU 21 of the reading device 2 may acquire coordinate data that indicate the position where the touch panel is pressed. When a check mark is written in the check box 111B of the form 111, the CPU 21 of the reading device 2 may transmit to the smart phone 19 the stroke data that the CPU 21 creates in a case where the CPU 21 determines that the check mark is written in the check box 111B of the form 111.

It is acceptable for the format of the form 111 not to be specified by the CPU 21 of the reading device 2. The format of the form 111 may be specified by the CPU 41 of the smart phone 19. The format of the form 111 may be input by the user via the touch panel 191. The CPU 41 may specify the format of the form 111 based on format information that is input about the format.

The method by which the CPU 41 determines which one of the first file and the second file to create in a case where the format of the form 111 is the third format is not limited to the method in the above embodiment. The threshold value (90%) for the ratio that is used in the determination at Step S67 may be another value. For example, the CPU 41 may determine which one of the first file and the second file to create based on the relationship between the length, in the left-right direction, of the specified rectangle and the length, in the left-right direction, of the form 111 on which the line image is written. The CPU 41 may determine which one of the first file and the second file to create based on the relationship between the surface area of the specified rectangle and the surface area of the form 111 on which the line image is written, for example. A command that indicates which one of the first file and the second file to create may be received via the touch panel 191, for example. The CPU 41 may then determine which one of the first file and the second file to create in accordance with the received command.

The method of specifying the area of the smallest rectangle that is to be included in the image that is the basis for the second file may be modified. For example, the smart phone 19 may store in the flash ROM 43, in advance, information for specifying rectangles that have sizes that correspond to different sizes of characters and different numbers of characters. In a case where the character string is written on the form 122, the smart phone 19 may then specify the size of the characters and the number of the characters that are included in the written character string. Then, based on the information stored in the flash ROM 43, the smart phone 19 may specify the rectangle that corresponds to the specified size and number of characters. The smart phone 19 may then create, as the second file, a file for an image that includes the character string that is written inside the specified rectangle.

In a case where the format of the form 111 is the first format, it is also acceptable for the smart phone 19 not to include in the image the printed pattern that is printed on the form 121. In a case where the format of the form 111 is the second format, it is acceptable for the smart phone 19 to include in the image the printed pattern that is printed on the form 122.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. An apparatus comprising:
a processor; and
a memory configured to store computer-readable instructions, wherein the computer-readable instructions, when executed by the processor, cause the apparatus to perform processes comprising:
acquiring type information indicating a type of a paper medium;
acquiring line information indicating a plurality of positions on the paper medium, the line information being information configured to specify a line image written on the paper medium;
defining an image area as one of a first area and a second area, based at least on the acquired type information, the image area being an area included in an image serving as a basis for an image file, the first area being an entire area of the paper medium on which the line image specified by the line information is written, and the second area including the line image specified by the line information and an immediate vicinity of the line image; and
creating the image file for the image including the defined one of the first image area and the second image area.

2. The apparatus according to claim 1, wherein
the computer-readable instructions, when executed by the processor, further cause the apparatus to perform a process comprising:
defining, in a case where the image area is not defined based solely on the type information, the image area as one of the first area and the second area, based on whether a relationship between a first length and a second length satisfies a specified condition, the first length being a distance, in a specified direction, between two positions, among the plurality of positions indicated by the line information, the two positions being most distant positions from each other in the specified direction, and the second length being a length of the paper medium in the specified direction.

3. The apparatus according to claim 2, wherein
the defining the image area based on whether the relationship between the first length and the second length satisfies the specified condition includes:
determining whether a ratio of the first length to the second length is not less than a specified value;
defining the image area as the first area in response to determining that the ratio is not less than the specified value; and
defining the image area as the second area in response to determining that the ratio is less than the specified value.

4. The apparatus according to claim 1, wherein
the second area is an area inside a smallest rectangle encompassing the line image.

5. The apparatus according to claim 1, wherein
the creating the image file includes, in response to defining the image area as the second area, creating the image file for the image further including a printed pattern, the printed pattern being a pattern printed in advance on the paper medium indicated by the acquired type information.

6. A non-transitory computer-readable medium storing computer-readable instructions that, when executed by a processor of an apparatus, cause the apparatus to perform processes comprising:
acquiring type information indicating a type of a paper medium;
acquiring line information indicating a plurality of positions on the paper medium, the line information being information configured to specify a line image written on the paper medium;
defining an image area as one of a first area and a second area, based at least on the acquired type information, the image area being an area included in an image serving as a basis for an image file, the first area being an entire area of the paper medium on which the line image specified by the line information is written, and the second area including the line image specified by the line information and an immediate vicinity of the line image; and
creating the image file for the image including the defined one of the first image area and the second image area.

7. The non-transitory computer-readable medium according to claim 6, wherein
the computer readable instructions, when executed by the processor, further cause the apparatus to perform a process comprising:
defining, in a case where the image area is not defined based solely on the type information, the image area as one of the first area and the second area, based on whether a relationship between a first length and a second length satisfies a specified condition, the first length being a distance, in a specified direction, between two positions, among the plurality of positions indicated by the line information, the two positions being most distant positions from each other in the specified direction, and the second length being a length of the paper medium in the specified direction.

8. The non-transitory computer-readable medium according to claim 7, wherein
the defining the image area based on whether the relationship between the first length and the second length satisfies the specified condition includes:
determining whether a ratio of the first length to the second length is not less than a specified value;
defining the image area as the first area in response to determining that the ratio is not less than the specified value; and
defining the image area as the second area in response to determining that the ratio is less than the specified value.

9. The non-transitory computer-readable medium according to claim 6, wherein
the second area is an area inside a smallest rectangle encompassing the line image.

10. The non-transitory computer-readable medium according to claim 6, wherein
the creating the image file includes, in response to defining the image area as the second area, creating the image file for the image further including a printed pattern, the printed pattern being a pattern printed in advance on the paper medium indicated by the acquired type information.
